(19) United States
(12) Patent Application Publication
(10) Pub. No.: US 2015/0170353 A1
(43) Pub. Date: Jun. 18, 2015

(54) METHOD AND DEVICE FOR ASSESSING THE SURFACE CONDITION OF RUBBER OR PLASTIC STRANDS

(71) Applicant: AKADEMIA GÓRNICZO-HUTNICZA IM. STANISLAWA STASZICA, Krakow (PL)

(72) Inventors: Jerzy Kwasniewski, Krakow (PL); Szymon Molski, Krakow (PL); Tomasz Krakowski, Krakow (PL); Hubert Ruta, Radom (PL)

(73) Assignee: AKADEMIA GÓRNICZO-HUTNICZA IM. STANISLAWA STASZICA, Krakow (PL)

(21) Appl. No.: 14/403,863

(22) PCT Filed: Feb. 7, 2013
(86) PCT No.: PCT/PL2013/000013

§ 371 Date: Nov. 25, 2014

(30) Foreign Application Priority Data
Jun. 15, 2012 (PL) P.399531

(51) Int. Cl. G06T 7/00

(52) U.S. Cl. CPC G06T 7/0004; G06T 2207/10004; G06T 2207/30164

(57) ABSTRACT

A device for assessing technical condition of the surface of strands having an infrared detector located over the examined structure of strand at appropriate distance and in an antireflection shield, whereas uniformity of the temperature gradient over the whole surface of the examined structure of strand is ensured by a temperature generator after which temperature sensors are located. A method is also provided.

### CROSS REFERENCE TO RELATED APPLICATIONS

This application relates to and claims priority from PCT Ser. No. PCT/PL2013/000013 filed Feb. 7, 2013, which in turn claims priority form Polish Ser. No. P.399531 filed Jun. 15, 2012, the entire contents of which are incorporated herein by reference.

### FIGURE SELECTED FOR PUBLICATION

FIG. 1

### BACKGROUND OF THE INVENTION

1. Field of the Invention

The present invention relates to a device for assessing technical condition of the surface of strands made of rubber or plastic and a method of assessing technical condition of strands made of rubber or plastic offering the possibility to implement the solution also for assessing technical condition of the surface of the belt rubber mantle of belt conveyors used in the mining industry.

2. Description of the Related Art

Known from description of Polish patent PL 181202, the entire contents of which are incorporated by reference, is a device for measuring of stretching and breaking force of strands that has hydraulic actuators attached by their bases to the front plate of a frame, with piston rods of said actuators mounted in a transversal movable beam moving on guides by means of carriages provided with rollers. In the middle of the movable beam, the front catch is mounted. In the rear plate, a rear catch is installed with grooves for edged ring locking position of the catch in the rear plate. The front catch is attached to the beam by means of a pin on which a bushing is mounted with strain sensors glued on it. The rear travelling catch allows to bring the catches close to each other for the required distance so that both short and long elements can be tested.

In the framework of modernization of lift technology, steel-polyurethane strands are used instead of steel cables. To asses the quality of such structure in the course of service it is necessary to determine both technical condition of steel cords and the state of polyurethane mantle surface.

The presented idea allows users to assess condition of the surface and possible presence of structure cracks or gaps in the mantle. The problem of carrying out inspection of the rubber mantle surface in belt conveyors where people can be occasionally transported on the belts, also remains unsolved. Before each running cycle in which people are to be carried, the belt must be inspected visually for possible cracks which is obviously a time-consuming procedure. Application of the present invention would eliminate human intervention and increase detectability of defects.

Accordingly, there is a need for an improved device for assessing technical conditions of the surface of strands.

### ASPECTS AND SUMMARY OF THE INVENTION

In response, it is now recognized that the inventors have provided a device for assessing technical condition of the surface of strands made of rubber or plastic comprising temperature generator, temperature detector, interface, image analyzer, and decision element is characterized in that it has an infrared detector positioned over the examined strand structure at appropriate distance and in an antireflection shield, whereas uniformity of the temperature gradient over the whole surface of the examined strand structure is ensured by a temperature generator after which temperature sensors are located.

According to one aspect of the present invention, there is provided a device for assessing technical condition of the surface of strands made of rubber or plastic comprising temperature generator, temperature detector, interface, image analyzer, and decision element is characterized in that it has an infrared detector located over the examined structure of strand at appropriate distance and in an antireflection shield, whereas uniformity of the temperature gradient over the whole surface of the examined structure of strand is ensured by a temperature generator after which temperature sensors are located. A method of assessing technical condition of strands made of rubber or plastic is characterized in that that signals from sensors measuring the temperature gradient and the signal from the transducer providing non-contact and/or contact measurement of velocity of strand and the image from interface of detector are transmitted to image analyzer and decision element.

According to another aspect of the present invention, a method of assessing technical condition of the surface of strands made of rubber or plastic is characterized in that signals from sensors measuring the temperature gradient and the signal from the transducer for non-contact and/or contact strand motion velocity measurement as well as the image from the detector's interface are transmitted to an image analyzer and to a decision element.

According to another alternative aspect of the present invention, the device for assessing technical condition of the surface of strands made of rubber or plastic comprises the following components:

According to another alternative aspect of the present invention, there is provided a machine vision system in the infrared range; as opposed to the computer vision that is focused mainly on image processing on the hardware level, the machine vision requires the use of additional I/O (input/output) devices and computer networks for transmitting the resulting information to other elements of the analyzing system. The machine vision falls into the category of engineering dealing with computer science, optics, mechanics, and industrial automatics. Machine vision systems are used on a continuously increasing scale to solve industrial inspection problems, allowing for full automation of the inspection process at improved precision and efficiency.

The above and other aspects, features and advantages of the present invention will become apparent from the following description read in conjunction with the accompanying drawings, in which like reference numerals designate the same elements.

### BRIEF DESCRIPTION OF THE DRAWINGS

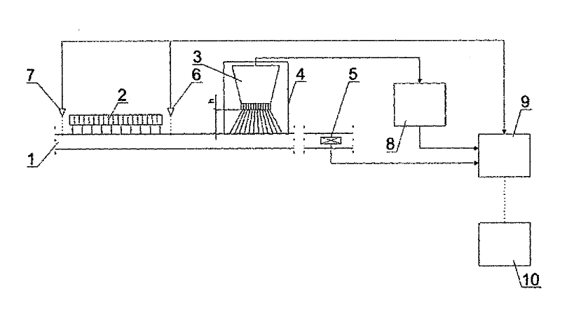

FIG. 1 is a schematic layout for the proposed device for operating according to the proposed method.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

According to one exemplary embodiment of the present invention as seen in the figures, the device is equipped with infrared detector 3 located under the examined strand 1 at distance h and in an antireflection shield 4. The detector's observation field depends on the distance h guaranteeing appropriate resolution of the image. In the strand 1, temperature gradient is generated by means of generator 2. In the measuring system, temperature is measured by sensors 6 and 7 (in the MEMS technology—before and after the temperature gradient generator) and temperature values are transmitted to image analyzer 9. The measured temperature provides the feedback used in the image analyzer. The image from interface of detector 8 is also transmitted to the image analyzer 9. This can be also e.g. an operator's computer in which qualitative analysis of the image and localization of defects is carried out. For localization of defects, non-contact or contact strand motion velocity measurement 5 is used. The system operates in real time. A very important feature of the device is the method used to generate a temperature gradient in the inspected structure (continuous or pulsed).

The method of assessing technical condition of the surface of strands made of rubber or plastic is characterized in that signals from sensors 6, 7 measuring temperature gradient and the signal from the sensor 5 for non-contact and/or contact measurement of motion velocity of strand 1 as well as image from interface of detector 8 are transmitted to image analyzer 9 and decision element 10.

The device for assessing technical condition of the surface of strands made of rubber or plastic comprises the following components:
sensor with infrared detector 3 (digital or analog camera with optics);
camera interface for image digitalization 8 (the so-called “frame interceptor”);
image analyzer 9 (usually a PC computer or integrated processor, e.g. DSP); (In some cases, all elements listed above are components of a single device known as the intelligent camera which, besides the image capturing system, comprises a processor function of which consists in “picking up” required information from the image without necessity to implement any external image processing device and the interface sending the generated information to other devices.)
I/O (input/output) device or communication links (e.g. RS-232) used to send reports on the system operation results;
a specialized source of temperature gradient 2 adapted to the system;
sensors 6, 7 verifying the image obtained in analyzer 8;
a program for image processing and detecting common features of images.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

1-2. (canceled)

3. A device for assessing technical condition of the surface of strands made of rubber or plastic comprising:
a temperature generator, a temperature detector, an interface detector, an image analyzer, and a decision element operatively arranged in that said device further comprises an infrared detector (3) located over an examined structure of a selected strand (1) at an appropriate distance (h) and operatively positioned within an antireflection shield (4);
whereas a uniformity of a temperature gradient over en entire portion of said e surface of an examined strand structure (1) is ensured by said temperature generator (2) after which said temperature detector having respective temperature sensors (6 and 7) are located.

4. A method of assessing technical condition of the surface of strands made of rubber or plastic, comprising the steps of:
operatively providing a temperature generator, a temperature detector, an interface detector, an image analyzer, and a decision element operatively arranged in that said device further comprises an infrared detector located over an examined structure of a selected strand at an appropriate distance (h) and operatively positioned within an antireflection shield;
measuring signals from a first and a second temperature sensor in said temperature detector;
characterizing:
(i) said signals as a temperature gradient;
(ii) a signal from a transducer providing a non-contact and/or contact measurement of a velocity of motion of the strand; as well as
(iii) an image from said interface of detector; and
transmitting said signals and said images to said image analyzer and said decision element.
